(19) United States
(12) Patent Application Publication
(10) Pub. No.: US 2026/0124976 A1
(43) Pub. Date: May 7, 2026

(54) VEHICLE SEAT WITH ADJUSTABLE CONSOLE

(71) Applicant: GRAMMER Aktiengesellschaft, Ursensollen (DE)

(72) Inventors: FLORIAN SCHANDERL, Schwarzenfeld (DE); JOHANNES FILLEP, Birgland (DE)

(21) Appl. No.: 19/359,875

(22) Filed: Oct. 16, 2025

(30) Foreign Application Priority Data
Nov. 4, 2024 (DE) 102024132002.8

(51) Int. Cl. B60N 2/75

(52) U.S. Cl. CPC B60N 2/77; B60N 2/767; B60N 2/797

(57) ABSTRACT

A vehicle seat (1) includes a seat part (2), a vehicle seat base (4) supporting the seat part (2), an armrest (6a), and a first console (3a) with an operating device (10). The armrest (6a) and the first console (3a) also extend predominantly adjacent to the seat portion (2) and/or the vehicle seat base (4). The first console (3a) is attached to the vehicle seat base (4) by the first console carrier (9a) to the vehicle seat base (4). The armrest (6a) is fixedly arranged on the first console (3a) and the first console (3a) with the armrest (6a) and the operating device (10) is connected to the vehicle seat base (4) via the console carrier (9a) and can be rotated through an angle of rotation α about an axis of rotation (D) extending in a width direction (Y) in order to simultaneously adjust the position of a point of support (A) for an passenger elbow on the armrest (6a) and a point of grip (G) for an passenger hand on the operating device (10) in relation to the seat part (2) at the same time. The console carrier (9a) has the axis of rotation (D) in a front region and has at least one lever element (13) that can be raised in a rear region. Rotation of the first console (3a) about the axis of rotation (D) can be controlled by raising or lowering the lever element (13).

### CROSS-REFERENCE TO RELATED APPLICATIONS

This application claims priority to German Patent Application 102024132002.8 filed on Nov. 4, 2024, the contents of which are incorporated by reference herein in their entirety.

### TECHNICAL FIELD

The invention relates to a vehicle seat comprising a seat part, a vehicle seat base supporting the seat part, an armrest, and a first console with an operating device, wherein the armrest and the first console also extend predominantly next to the seat part and/or the vehicle seat base, and the first console is attached to the vehicle seat base by the first console carrier.

### BACKGROUND

Commercial vehicles, such as agricultural machinery, construction machinery, or transport vehicles, usually have consoles extending next to the seat part, which serve as supports for operating devices such as joysticks or control panels. To prevent the arms of a passenger from becoming tired or tense when holding a joystick or other operating device, armrests are attached to the vehicle seat on which the passenger can rest their arms. Since different passenger are of different heights and have different arm lengths, the height of the armrest must firstly be adjusted so that the elbow rests on the armrest for comfortable operation of the control unit. In a next step, the angle of the armrest must be adjusted so that the passenger can reach the operating device. In a final step, the angle of the control unit relative to the armrest must be adjusted so that the wrist is not overextended. These various adjustment steps are very time-consuming and tedious. In addition, the individual components must offer a wide range of adjustment options. Consequently, the problem to be solved is to provide a vehicle seat in which an improved adjustment system simplifies the adjustment of the console and reduces the manufacturing costs and assembly effort of the vehicle seat.

### SUMMARY

Therefore, a vehicle seat according to the invention is provided, comprising a seat part, a vehicle seat base supporting the seat part, an armrest, and a first console with an operating device, wherein the armrest and the first console also extend predominantly next to the seat part and/or the vehicle seat base, and the first console is attached to the vehicle seat base by the first console carrier. The armrest is fixedly arranged on the first console, and the first console is connected to the armrest and the operating device via the console carrier to the vehicle seat base and can be rotated about an axis of rotation extending in a width direction through an angle of rotation α in order to simultaneously adjust the position of a support point for an passenger elbow on the armrest and a grip point for an passenger hand on the operating device in relation to the seat part, wherein the console carrier has the axis of rotation in a front region and has at least one lever element that can be raised in a rear region, wherein rotation of the first console about the axis of rotation can be controlled by raising or lowering the lever element.

The longitudinal, width, and height directions describe a Cartesian coordinate system X, Y, Z that is oriented to the main directions of extension of the vehicle seat. Thus, the seat part extends essentially in the longitudinal and width directions, whereas the height direction extends perpendicular to the longitudinal and width directions.

Usually, the vehicle seat has a vehicle seat base that is connected to the body of a vehicle. A vehicle seat superstructure is arranged on the vehicle seat base, which usually comprises a seat part, a backrest, and a headrest. The vehicle seat base usually has a spring system that cushions relative movement between the vehicle seat and the body in the height direction and allows the seat part to be adjusted in the height direction. In addition, the vehicle seat superstructure can be moved in the longitudinal direction and the backrest can be rotated in the width direction. Various attachments, such as consoles, are typically arranged on the vehicle seat base.

A console is a component that is arranged on the side of the vehicle seat and serves as a carrier structure for various other components. In particular, operating devices such as joysticks, control levers, or buttons are attached to the console, which are used to control the vehicle or attached work equipment or machines. To ensure easy access, the console can usually be adjusted not only in longitudinal direction but also in height direction. Adjustment forwards and backwards serves to adjust the distance between the upper body of a passenger and the console. For smaller passengers, it may be necessary, due to the length of their arms, to move the console and any control unit closer to the upper body, i.e. backwards, in order to be able to use the console and any control unit comfortably. For tall passenger, the opposite may be the case due to longer arms, i.e., it may be necessary to move the console far away from the upper body, i.e., forward. Operating devices, in particular joysticks or steering wheels, usually have a grip point where the passenger hand grasps the operating device. This does not have to be an actual point but can also be an area or region where the hand touches the operating device. The point of contact of a wrist on the operating device, for example a keyboard or a control panel, can also be such a grip point. The point of contact of the elbow, as the beginning of the forearm, thus forms the transition from the arm to the armrest. Both the grip point and the contact point remain essentially unchanged, with the exception of shifts in the grip point induced by the operation of the operating device and can therefore be regarded as constant. This applies in particular during an operating cycle of the operating device, i.e., a period during which the operating device is in use.

According to the invention, the armrest is fixedly arranged on the console. Preferably, the operating device is also fixedly arranged on the console, so that the armrest, console, and operating device form a single unit. Since this can be rotated about an axis of rotation extending in the width direction, both the grip point and the support point can be rotated together through the same angle α about the axis of rotation. This means that when the armrest is tilted, the tilt of the console no longer needs to be adjusted, as both are rotated together.

The axis of rotation is located in the front area of the console. Preferably, the axis of rotation is located in an area below the grip point or, particularly preferably, in an area below the passenger wrist. Advantageously, this results in a negligible small displacement in the height direction for the grip point when rotating by a small angle α. For the support point, on the other hand, there is a noticeable displacement in the height direction. Preferably, the adjustable lever element is located in an area below the support point. Particularly preferably, the lever element drives a rotation of the console.

According to a particularly preferred embodiment, the rotation of the first console in a first direction of rotation allows the support point to be moved upward in the height direction, and the rotation of the first console in a second direction of rotation allows the support point to be moved downward in the height direction.

The rotation of the console thus advantageously allows the support point to be adjusted in the height direction and adapted to a passenger. This combines both the height adjustment of the armrest and the tilt adjustment.

According to a particularly preferred embodiment, the lever element is a push crank with an L-shaped crank, which is connected to a linear drive at a short end and the short end is directed downwards in the height direction, a long end is oriented longitudinally toward the rear, and the crank is rotatably mounted on the first console carrier in the connection area between the short and long ends.

It is preferred that the linear drive can be operated from the front of the vehicle seat. In order to control the reliable rotational movement of the console, the linear drive is connected to the L-shaped crank, which, since it forms a right angle and is mounted on the console support so that it can rotate around the crown, converts the movement of the linear drive mainly in the longitudinal direction into a movement of the crank mainly in the height direction.

In a particularly preferred embodiment, the long end of the crank is connected to the first console in a rear lower area of the first console, the rear lower area of the first console being arranged opposite the front area in the longitudinal direction.

The longitudinally opposite arrangement of the crank and the axis of rotation creates the greatest possible lever, so that the console can be rotated with minimal effort. This is necessary because consoles with armrests and operating devices, due to the stability they must provide and the electronics installed, are very heavy.

In a particularly preferred embodiment, the linear drive has a threaded spindle with a guide nut, whereby a rotary movement of the threaded spindle can be converted into a linear movement by the guide nut, and the linear movement can be converted into a rotary movement by the crank, thus allowing the crank to be raising or lowering.

The threaded spindle has proven to be a simple and reliable linear drive. The threaded spindle can be used to continuously adjust the console. The threaded spindle can be driven manually via a star grip or via an actuator. Alternatively, it would also be conceivable for the lever element to be driven directly via an actuator.

In a particularly preferred embodiment, the vehicle seat has a second console carrier and a second console, with a second armrest arranged on the upper side of the second console, whereby the second console, the second console carrier, and the second armrest are arranged opposite the first console, the first console carrier, and the first armrest in relation to the seat part.

Due to the abundance of operating devices, particularly in agricultural and construction machinery, a vehicle seat usually comprises one console on each side, right and left.

According to a particularly preferred embodiment, the second console is arranged parallel to the first console and can rotate about the axis of rotation in a front area of the second console.

Since the second console should also be adjustable to the size of the passenger, the second console is also arranged to be rotatable. Since the passenger are essentially symmetrical on the right and left, it is desirable that both consoles be equally adjustable. For this purpose, both consoles are arranged to be rotatable about the same axis of rotation.

According to a particularly preferred embodiment, the second console carrier has a second crank, wherein the first crank and the second crank are arranged opposite each other and parallel to each other with respect to the seat part, wherein the second crank is rotatably mounted on the second console carrier, wherein the first crank and the second crank are connected to each other via a shaft, wherein rotation of the first crank can be transmitted to the second crank via the shaft.

Since the second console must also be adjustable, it has a second crank analogous to the first console. In contrast to the first crank, it is sufficient for the second crank to be I-shaped, since it is not connected to a linear drive. One end of the crank is rotatably arranged on the second console carrier and the other end is connected to the console. In order to achieve rotation of the second console, the second crank is connected to the first crank via a shaft. Both cranks can rotate around the axis of rotation of the shaft.

According to a particularly preferred embodiment, the first console and the second console, and thus the first armrest and the second armrest, are adjusted in parallel and synchronously when one of the two is adjusted.

As mentioned above, the passengers are essentially symmetrical, so that both consoles are usually set to the same height. To avoid having to adjust both consoles one after the other, both consoles are connected to each other via the shaft, so that an adjustment of the first console is transferred in parallel and synchronously to the second console.

If different height settings are desired for both consoles, an adjustment mechanism can be provided on the second console, in particular between the shaft and the crank, which allows the second console to be rotated independently of the first.

According to a particularly preferred embodiment, an angle β between the grip point and the support point and a main extension axis of the armrest remains constant when the console is adjusted.

The simultaneous adjustment of the armrest and grip point by rotating the console combines several adjustment processes, eliminating the need for cumbersome readjustment of individual components. Since the angle β remains constant, the user's wrist is not overextended when adjusting the armrest or control unit, enabling comfortable and healthy working.

Further advantageous embodiments are apparent from the following description in conjunction with the drawing. Hereby shows:

### BRIEF DESCRIPTION OF THE DRAWINGS

FIG. 1 a general view of a vehicle seat according to the invention;

FIG. 2 a side view of a vehicle seat according to the invention;

FIG. 3 an isometric view of a first console carrier and a second console carrier;

FIG. 4a a first console carrier in a center position;

FIG. 4b a first console support in a high position;

FIG. 4c a first console support in a low position; and

FIG. 5 a schematic representation of the rotation of the console.

For clarity, some reference symbols have been omitted in the figures.

### DETAILED DESCRIPTION

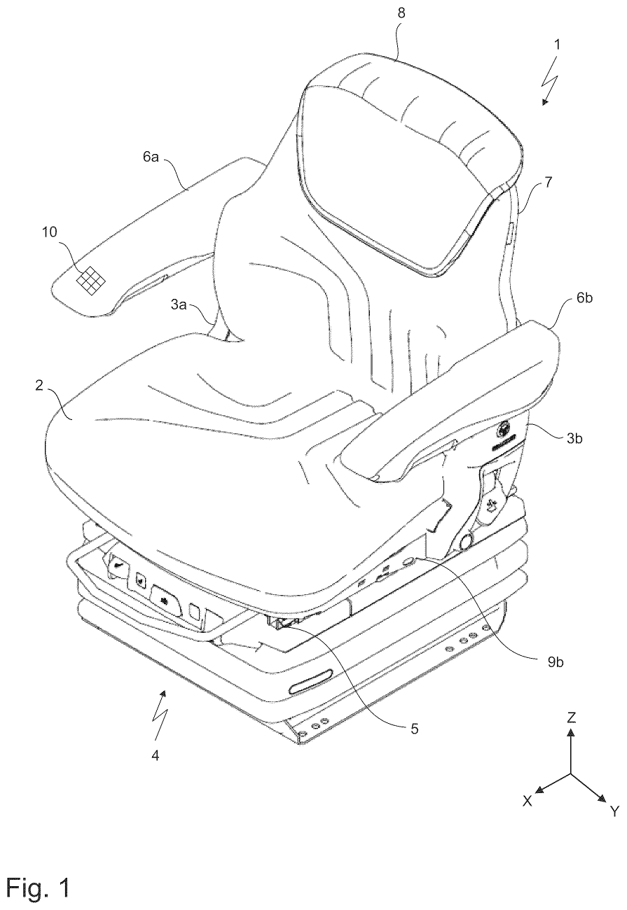

FIG. 1 shows an overall view of a vehicle seat 1 according to the invention. The vehicle seat 1 can be divided into a vehicle seat base 4 and a vehicle seat superstructure arranged above it and supported by it. The vehicle seat superstructure comprises a seat part 2, which extends essentially parallel to the plane from the longitudinal direction X and the width direction Y. A backrest 7 is arranged on the seat part, which extends essentially in the height direction Z and in the width direction Y. The backrest 7 is arranged here almost at right angles to the seat part 2 and oriented in the longitudinal direction, whereby the angle between the seat part 2 and the backrest 7 can be changed by a swivel mechanism. A headrest 8 is additionally arranged at the upper end of the backrest 7. A first console 3a extends to the right and a second console 3b extends to the left, laterally adjacent to the seat part 2 and also laterally adjacent to the backrest 7. Both consoles 3a and 3b can be rotated about the width direction Y relative to the seat part 2. For this purpose, the consoles 3a and 3b are not attached to the seat part 2, but to the vehicle seat base 4 by the first console carrier 9a and 9b. An operating device 10 in the form of a keypad 10 is arranged on the upper side of the first console 3a in a front area. The vehicle seat base 4 is bolted to the underside of the vehicle body. In a lower section, the vehicle seat base 4 has a spring device, not visible here, which enables spring movement and height adjustment of the seat structure. Two adjustment rails 5 are arranged above the spring device, running in the longitudinal direction X. Only one adjustment rail 5 is visible here, which is arranged on the left side of the vehicle seat 1. Another is arranged in the width direction opposite on the right side of the vehicle seat. The seat part 2 is attached to the adjustment rails 5 via spacers and can thus be moved in the longitudinal direction relative to the spring device or the remaining part of the vehicle seat base 4. An armrest 6a and 6b is arranged on each of the consoles 3a and 3b shown here.

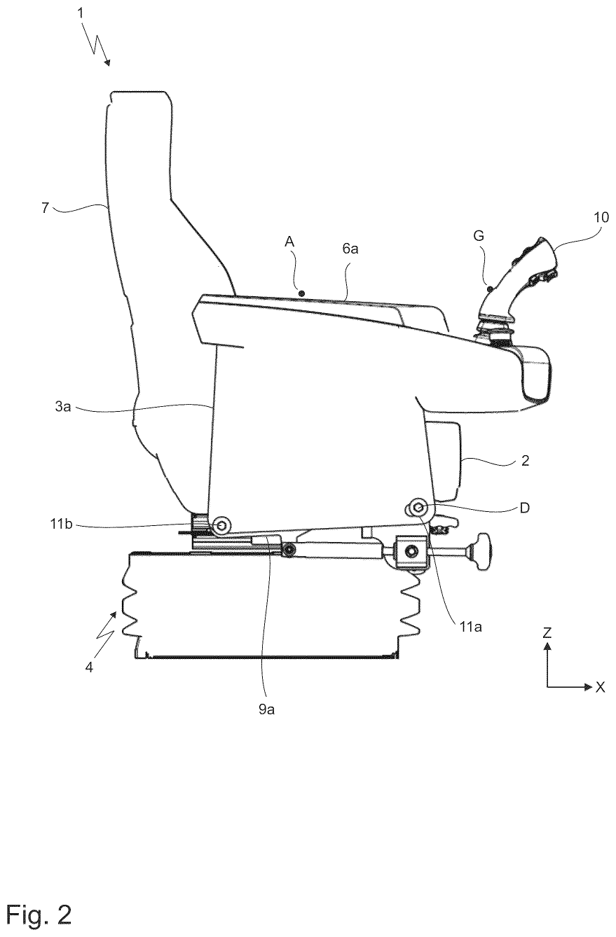

FIG. 2 shows a side view of a vehicle seat 1 according to the invention. The first console 3a is arranged on the right side of the vehicle seat and extends predominantly next to the seat part 2. By a slide not shown here, the console 3a can be moved forwards and backwards in the longitudinal direction X. The first console carrier 9a is attached to the vehicle seat base or the slide and has a bearing 11a and 11b in a front and rear area respectively. The console 3a, which has a roughly rectangular structure, is mounted in a lower front area near a lower front corner so that it can rotate about the axis of rotation D on the bearing 11a. In a lower rear area, near a lower rear corner, the console 3a is connected to the second bearing 11b. Starting from the first console carrier 9a, the console 3a extends in the height direction Z beyond the seat part 2. The armrest 6a is fixed to the upper side of the console 3a. It extends from a rear end, which is arranged in the longitudinal direction X at the height of the backrest 7, to a front end, which is arranged in the longitudinal direction X at the height of the axis of rotation D. Adjacent to the armrest 6a, the console 3a transitions into a holder for the joystick 10. In a rear area of the armrest, between the first front bearing 11a and the first rear bearing 11b in the longitudinal direction, the support point A for the passenger elbow is located on the surface of the armrest 6a. The grip point G is located in the center of the top of the joystick 10. The exact position of the support point A and the grip point G is not decisive, but rather that their position relative to each other remains constant.

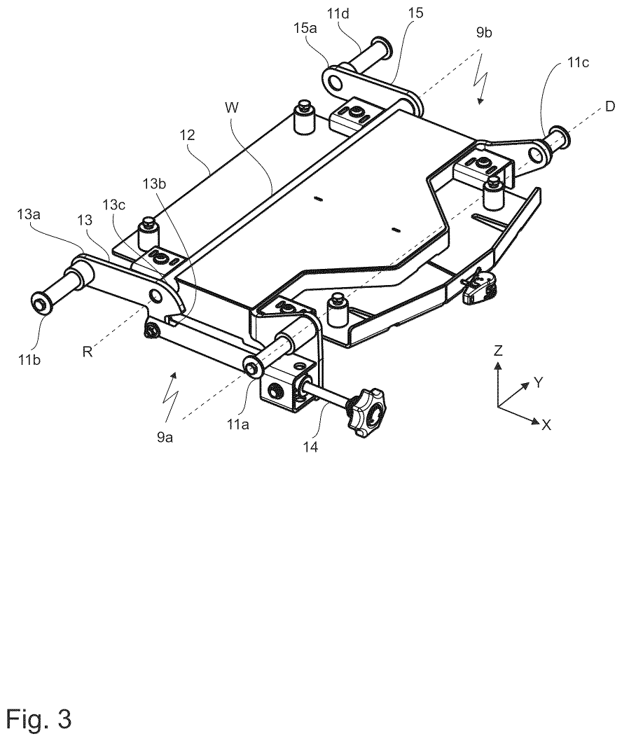

FIG. 3 shows an isometric view of a first console carrier 9a and a second console carrier 9b. The two console carriers 9a and 9b are arranged opposite each other on a slide 12. The first console carrier 9a has a lever element 13 that drives the rotation of the console about the axis of rotation D. For this purpose, the lever element is designed as an L-shaped crank 13 with a long arm 13a and a short arm 13b. Both arms 13a and 13b are arranged at right angles to each other, whereby in a central position of the console 3a, the long arm 13a is aligned rearward in the longitudinal direction X and the short arm 13b is aligned downward in the height direction. At the crown 13c between the two arms 13a and 13b, the crank 13 is mounted so that it can rotate about a rotational axis R. The rotational axis is parallel to both the axis of rotation D and the width direction Y.

At the end of the long arm 13a opposite the crown 13c, the first rear bearing 11b is arranged in the form of a first rear bearing pin 11b extending outward in the width direction Y. The first front bearing 11a is also designed as an outwardly extending bearing pin 11a. Both bearing pins 11a and 11b are arranged parallel to each other. A linear drive 14 is also arranged below the first front bearing pin 11a. The linear drive is connected to an end of the short arm 13b opposite the crown 13c. The linear drive 14 is designed to deflect the free end of the short arm 13b mainly in the longitudinal direction X. This causes the entire crank 13 to rotate about the axis of rotation R, whereby the free end of the long arm 13a with the first rear pin 11b is deflected mainly in the height direction Z. Due to the connection between the first rear pin 11b and the first console 3a, the first console 3a is rotated by the deflection of the long arm 13a or by the deflection of the crank 13 by the angle α.

The crank 13 is connected to a second crank 15 via a shaft W. The shaft W extends along the axis of rotation R between the first crank 13 and the second crank 15. Both cranks 13 and 15 are connected to each other in a rotationally fixed manner by the shaft W, so that a deflection of the first crank 13 is also transmitted to the second crank 15. The second crank 15 comprises only a long arm 15a, which is connected at one end to the shaft to be rotatable about the axis of rotation R and has a second rear bearing pin 11d at the other end. The long arm 13a of the first crank 13 and the long arm 15a of the second crank 15, as well as the first rear bearing pin 11b and the second rear bearing pin 11d, are aligned parallel to each other. The second console carrier 9b also has a second front bearing pin 11c, which extends around the axis of rotation D in the width direction Y opposite the first front bearing pin 11a. The bearing pins 11a, 11b, 11c, and 11d are aligned in a manner that is particularly mirror-symmetrical to a mirror plane parallel to the longitudinal direction and to the height direction through the center of the vehicle seat 1.

A second console 3b, not shown here, is attached to the second bearing pins 11c and 11d. Due to the connection of the first crank 13 and the second crank 15 via the shaft W, both consoles are rotated synchronously when one of the two consoles 3a or 3b is rotated.

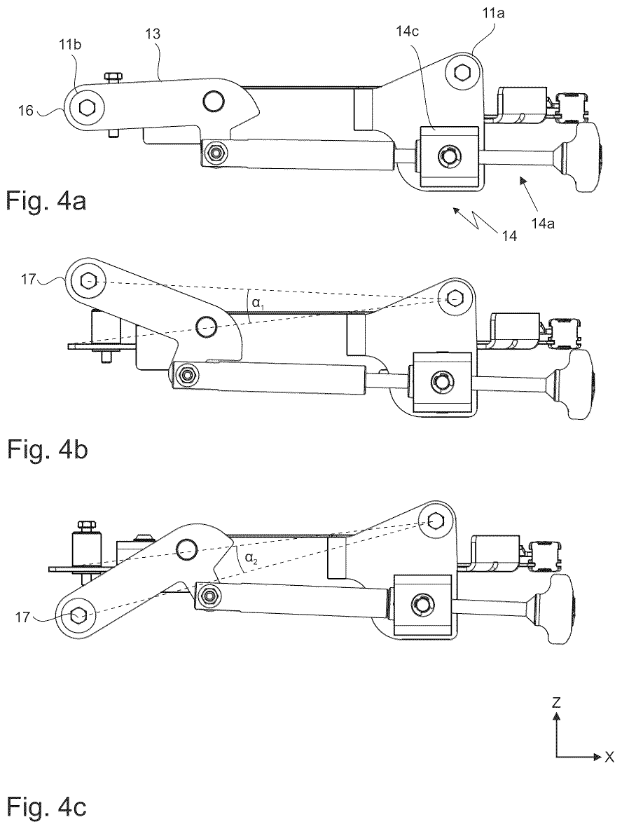

FIGS. 4a to 4c show the first console carrier 9a in a center position, a high position, and a low position. The linear drive 14 for driving the first crank 13 comprises a threaded spindle 14a which extends substantially parallel to the longitudinal direction up to a front side of the vehicle seat. A star grip 14b is arranged at the front end of the threaded spindle 14a. The threaded spindle 14a is mounted in a spindle bearing 14c so that it cannot be displaced in the longitudinal direction X. Finally, the rear end of the threaded spindle 14a engages with the thread of the guide nut. By screwing the spindle 14a into the nut thus allows the nut to be pulled closer to the bearing 14c, and unscrewing the spindle 14a from the nut thus allows the nut to be pushed further away from the bearing 14c. In FIG. 4b, crank 13 is shown in an upward deflected position by the linear drive 14. The first rear bearing pin 11b is deflected upward to such an extent that console 3a is rotated by α₁≈10°about the axis of rotation D. In FIG. 4c, the crank 13 is deflected downward so that the console is rotated downward by α₂≈−10° about the axis of rotation D. The degrees refer to the center position in FIG. 4a, in which α=0.

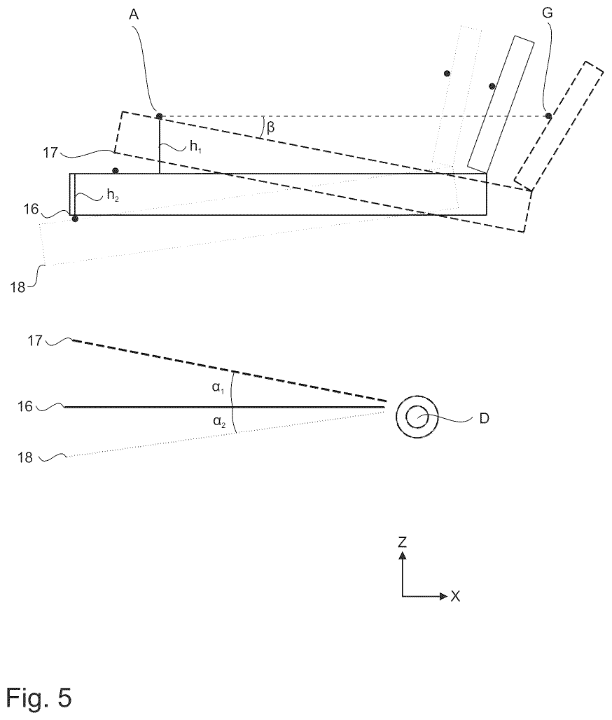

FIG. 5 shows a schematic representation of the rotation of the console 3a in relation to the three deflections shown in FIGS. 4a to 4c. The drawing with the solid line describes the center position 16 of the console 3a, the dashed line describes the high position 17, and the dotted line describes the low position 18. The upper part shows a schematic representation of the armrest 6a with a support point A and a joystick 10 with a grip point G, while the lower part shows a schematic representation of the lower end of the console 3a and the axis of rotation D or the bearing pin 11a. By rotating the console 3a upward by the angle α₁, the support point A is moved upward by the height h₁ from the center position 16. In contrast_{,} when rotated by the angle α_{2,} the support point A is moved downward by the height h₂ from the center position by the angle α₂. Depending on the arm length of the passenger, the height of the support point A of the armrest 6a can be adjusted to the height desired by the passenger by rotating the console 3a. At the same time, the wrist angle β between the grip point G and the support point A and a main extension axis of the armrest remains the same throughout the entire rotation of the console 3a.

### List of Reference Symbols

1 Vehicle seat
2 Seat part
3a First console
3b Second console
4 Vehicle seat base
5 Adjustment rail
6a First armrest
6b Second armrest
7 Backrest
8 Headrest
9a First console carrier
9b Second console carrier
10 Operating device
11a First front bearing
11b First rear bearing
11c Second front bearing
11d Second rear bearing
12 Slide
13 Lever element
13a Long arm
13b Short arm
13c Crown
14 Linear drive
14a Threaded spindle
14b Star grip
14c Spindle bearing
15 Second crank
15a Long arm of the second crank
16 Center position
17 High position
18 Low position
h₁ Height between center and high position
h₂ Height between center and low position
α Angle of rotation
α₁ Angle between center and high position
α₂ Angle between center and low position
A Support point on the armrest
G Grip point on the joystick
D Rotation axis of the console
R Rotation axis of the shaft
X Vehicle seat longitudinal direction
Y Vehicle seat width direction
Z Vehicle seat height direction

1. Vehicle seat (1) comprising a seat part (2), a vehicle seat base (4) supporting the seat part (2), an armrest (6a) and a first console (3a) with an operating device (10), wherein the armrest (6a) and the first console (3a) also extend predominantly adjacent to the seat portion (2) and/or the vehicle seat base (4), and the first console (3a) is fastened to the vehicle seat base (4) by the first console carrier (9a), wherein
the armrest (6a) is fixedly arranged on the first console (3a) and the first console (3a) with the armrest (6a) and the operating device (10) is connected to the vehicle seat base (4) via the console carrier (9a) and can be rotated through an angle of rotation α about the axis of rotation (D) extending in a width direction (Y) in order to simultaneously adjust the position of a support point (A) for an passenger elbow on the armrest (6a) and a grip point (G) for an passenger hand on the operating device (10) in relation to the seat part (2) at the same time, wherein the console carrier (9a) has the axis of rotation (D) in a front region and has at least one lever element (13) that can be raised in a rear region, wherein rotation of the first console (3a) about the axis of rotation (D) can be controlled by raising or lowering the lever element (13).

2. Vehicle seat (1) according to claim 1, wherein
rotation of the first console (3a) in a first direction of rotation allows the support point (A) to be moved upward in a height direction (Z), and rotation of the first console (3a) in a second direction of rotation allows the support point (A) to be moved downward in the height direction (Z).

3. Vehicle seat (1) according to claim 1, wherein
the lever element (13) is a push crank with an L-shaped crank (13), which is connected to a linear drive (14) at a short end (13b) and the short end (13b) is directed downwards in the height direction (Z), a long end (13a) is directed rearward in the longitudinal direction (X), and the crank (13) is rotatably mounted on the first console carrier (9a) in the connection area between the short and long ends (13b, 13a).

4. Vehicle seat (1) according to claim 3, wherein
the long end of the crank (13a) is connected to the first console (3a) in a rear lower region of the first console (3a), wherein the rear lower region of the first console (3a) is arranged opposite the front region in the longitudinal direction (X).

5. Vehicle seat (1) according to claim 3, wherein
the linear drive (14) has a threaded spindle (14a) with a guide nut (14d), wherein a rotary movement of the threaded spindle (14) can be converted into a linear movement by the guide nut can be converted into a linear movement and the linear movement can be converted into a rotary movement by the crank (13), thereby allowing the crank (13) to be raised or lowered.

6. Vehicle seat (1) according to claim 1, wherein
the vehicle seat (1) has a second console carrier (9b) and a second console (3b), wherein a second armrest (6b) is arranged on the upper side of the second console (3b), wherein the second console (3b), the second console carrier (9b) and the second armrest (6b) of the first console (3a), the first console carrier (9a) and the first armrest (6a) are arranged opposite each other in relation to the seat part (2).

7. Vehicle seat (1) according to claim 6, wherein
the second console (3b) is arranged parallel to the first console (3a) and rotatable about the axis of rotation (D) in a front region of the second console (3b).

8. Vehicle seat (1) according to claim 7, wherein
the second console carrier (9b) has a second crank (15), wherein the first crank (13) and the second crank (15) are arranged opposite each other and parallel to each other with respect to the seat part (2), wherein the second crank (15) is rotatably mounted on the second console carrier (9b), wherein the first crank (13) and the second crank (15) are connected to each other via a shaft (W), wherein rotation of the first crank (13) can be transmitted to the second crank (15) via the shaft (W).

9. Vehicle seat (1) according to claim 6, wherein
the first console (3a) and the second console (3b), and thus the first armrest (6a) and the second armrest (6b), are adjusted in parallel and synchronously when one of the two is adjusted.

10. Vehicle seat (1) according to claim 1, wherein
an angle β between the grip point (G) and the support point (A) and a main axis of extension of the armrest (6a, 6b) remains constant when the consoles (3a, 3b) is adjusted.

11. Vehicle seat (1) according to claim 4, wherein the linear drive (14) has a threaded spindle (14a) with a guide nut (14d), wherein a rotary movement of the threaded spindle (14) can be converted into a linear movement by the guide nut can be converted into a linear movement and the linear movement can be converted into a rotary movement by the crank (13), thereby allowing the crank (13) to be raised or lowered.

12. Vehicle seat (1) according to claim 7, wherein, the second console (3b) is arranged parallel to the first console (3a) and rotatable about the axis of rotation (D) in a front region of the second console (3b).

13. Vehicle seat (1) according to claim 8, wherein the first console (3a) and the second console (3b), and thus the first armrest (6a) and the second armrest (6b), are adjusted in parallel and synchronously when one of the two is adjusted.
